(19) United States
(12) Patent Application Publication
(10) Pub. No.: US 2025/0192625 A1
(43) Pub. Date: Jun. 12, 2025

(54) AXIAL-FLUX MOTOR HAVING DOUBLE STATOR ASSEMBLIES AND SINGLE ROTOR ASSEMBLY AND UAV MOTOR DEVICE

(71) Applicant: METAL INDUSTRIES RESEARCH & DEVELOPMENT CENTRE, Kaohsiung (TW)

(72) Inventors: Chin-Hong CHANG, Kaohsiung (TW); Fu-Chuan HSU, Kaohsiung (TW); Jui-Ming HUA, Kaohsiung (TW); Chorng-Tyan LIN, Kaohsiung (CN); Pin-Jyun CHEN, Kaohsiung (CN); Yu-Lin CHI, Kaohsiung (CN)

(21) Appl. No.: 18/531,364

(22) Filed: Dec. 6, 2023

(51) Int. Cl. H02K 1/20; B64U 50/19; H02K 21/24

(52) U.S. Cl. CPC H02K 1/20; B64U 50/19; H02K 21/24

(57) ABSTRACT

An axial-flux motor includes: a shaft; a rotor assembly; a first stator assembly disposed on one side of the rotor assembly in an axial direction, wherein the first stator assembly includes a first base, and the first base is provided with first through holes; a second stator assembly, disposed on an other side of the rotor assembly in the axial direction, wherein the rotor assembly is located in a rotor space formed between the first stator assembly and the second stator assembly; and a wind scooper, fixed to the first base and provided with air inlets, wherein the air inlets are bell-shaped holes with a width decreasing from outside to inside, and the air inlets are communicated with the first through holes of the first base, so that an external airflow enters the axial-flux motor through the air inlets and the first through holes.

### BACKGROUND

### Technical Field

The present disclosure relates to an axial-flux motor, and in particular, to an unmanned aerial vehicle (UAV) motor device including an axial-flux motor.

### Related Art

An axial-flux motor is one of numerous kinds of motors, and can be applied to an electric vehicle, a wind turbine and the like. In addition, compared with a radial-flux motor, the axial-flux motor can improve efficiency and reduce a motor volume, thereby achieving characteristics of a light weight and a high power density. The axial-flux motor, like other motors, generates heat energy during operation. However, in the prior art, the axial-flux motor usually includes at least one water jacket inside. The water jacket is arranged corresponding to a stator assembly, and heat energy generated by the stator assembly is taken away by water flow flowing through the water jacket (this is water-cooled heat dissipation).

The current unmanned aerial vehicle (UAV) motor is mostly a radial-flux motor, but the efficiency and thrust of the radial-flux motor cannot be enhanced due to the limitation of space and weight of the UAV. Moreover, the UAV motor is a low-voltage and high-power motor product, and a high current can generate a lot of heat. Long-time operation can lead to burning of enameled wires of the motor. Conventional UAV motors all use air-cooled heat dissipation, and drive airflow by using blades, so that the motors can achieve the heat dissipation effect. A general method of heat dissipation of the motor is that the housing is provided with fins. However, the UAV motor has stricter requirements on a weight and a volume, the design of fins can effectively dissipate heat, but the design of fins is difficult to compress the overall volume and weight.

A patent document (the application publication No. CN109586508A) that has the title of invention: “AXIAL-FLUX MOTOR AND ELECTRICAL DEVICE” discloses an axial-flux motor, including: a motor body and a casing, wherein the casing is configured for covering the motor body. The motor body includes a shaft extending along a central axis; a rotor connected to the shaft, extending radially outward in the shape of a disc, and configured to rotate together with the shaft; and a stator located on one side of the rotor in an axial direction, and opposite to the rotor in the axial direction. The motor body further includes a fan blade connected to the shaft, located on a side of the rotor in the axial direction opposite to the stator, and located on a radial inner side of the stator. In this patent document, the fan blade is arranged in an internal space of the axial-flux motor, so as to suck cold air from the outside into the motor space, or exhaust hot air from the motor space to the outside, which is beneficial to heat dissipation for inside of the motor. Because the fan blade is arranged opposite to the stator in the radial direction, the stator can be cooled at a close distance, thereby improving cooling efficiency of the stator. However, the fan blade connected to the shaft disclosed in the above patent document still occupies the internal space of the axial-flux motor, which also complicates inside of the axial-flux motor.

Therefore, an axial-flux motor needs to be provided to resolve the forgoing problems.

### SUMMARY

An objective of the present disclosure is to provide an axial-flux motor, whose a wind scooper includes an air inlet.

To achieve the foregoing objective, the present disclosure provides an axial-flux motor, comprising: a shaft, extending in an axial direction; a rotor assembly, connected to the shaft and configured to rotate together with the shaft; a first stator assembly, disposed on one side of the rotor assembly in the axial direction, wherein the first stator assembly comprises a plurality of first stator windings, a first stator core portion, and a first base, the first stator windings correspond to permanent magnets of the rotor assembly in the axial direction, the first stator windings surround the first stator core portion by an annular arrangement, the first stator core portion is fixed to the first base, and the first base is provided with a plurality of first through holes; a second stator assembly, disposed on the other side of the rotor assembly in the axial direction, wherein the rotor assembly is located in a rotor space formed between the first stator assembly and the second stator assembly, whereby a magnetic flux to pass from the first stator assembly to the second stator assembly through the rotor assembly; and a wind scooper, fixed to the first base of the first stator assembly and provided with a plurality of air inlets, wherein the air inlets are bell-shaped holes with a width decreasing from outside to inside, and the air inlets are communicated with the first through holes of the first base, so that an external airflow enters the axial-flux motor through the air inlets and the first through holes.

The present disclosure further provides an unmanned aerial vehicle (UAV) motor device, comprising a propeller blade and the above-mentioned axial-flux motor, wherein the propeller blade is mounted to an end of the shaft of the axial-flux motor.

The axial-flux motor of the present disclosure has a structure of double stator assemblies and single rotor assembly, whereby a power density of the axial-flux motor can be effectively increased, and further the efficiency and thrust of the axial-flux motor can be enhanced. Furthermore, to enhance heat dissipation efficiency of the motor, the wind scooper of the axial-flux motor of the present disclosure is provided with the air inlets (for example, a special bell-shaped holes design), so that airflow generated by the propeller blade located above the wind scooper can enter an inside of the axial-flux motor more smoothly, so as to avoid generating airflow disturbance outside the axial-flux motor due to airflow obstruction, and further to affect flight balance of the UAV.

### BRIEF DESCRIPTION OF THE DRAWINGS

FIG. 1 is a schematic three-dimensional exploded view of an axial-flux motor according to an embodiment of the present disclosure.

FIG. 2 is a schematic three-dimensional assembly view of an axial-flux motor according to an embodiment of the present disclosure.

FIG. 3 is a schematic cross-sectional assembly view of an axial-flux motor according to an embodiment of the present disclosure.

FIG. 4 is a schematic three-dimensional exploded view of a rotor assembly of an axial-flux motor according to an embodiment of the present disclosure.

FIG. 5A and FIG. 5B are schematic three-dimensional exploded views I and II of a first stator assembly and a wind scooper of an axial-flux motor according to an embodiment of the present disclosure.

FIG. 6 is a schematic three-dimensional exploded view of a second stator assembly of an axial-flux motor according to an embodiment of the present disclosure.

FIG. 7 is a schematic three-dimensional view of a shaft of an axial-flux motor according to an embodiment of the present disclosure.

FIG. 8 is a schematic three-dimensional view of an unmanned aerial vehicle (UAV) motor device according to an embodiment of the present disclosure.

### DETAILED DESCRIPTION

To make the above object, features, and characteristics of the present disclosure more obvious and understandable, relevant embodiments of the present disclosure are described in detail below with reference to the drawings.

Embodiments of the present disclosure are described in detail below with reference to the drawings. The accompanying drawings are mainly simplified schematic diagrams and only schematically illustrate the basic structure of the present disclosure. Therefore, only components related to the present disclosure are marked in these drawings, the displayed components are not drawn based on the number, shape, and dimension scale during implementation, the specifications and dimensions during actual implementation are actually an optional design, and the layout of the components may be more complicated.

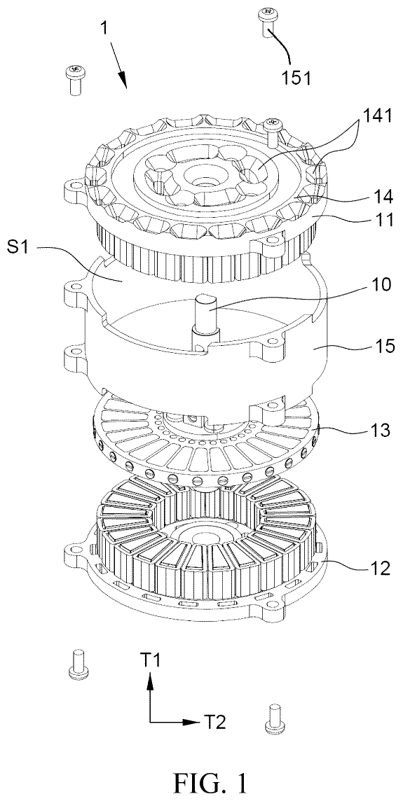

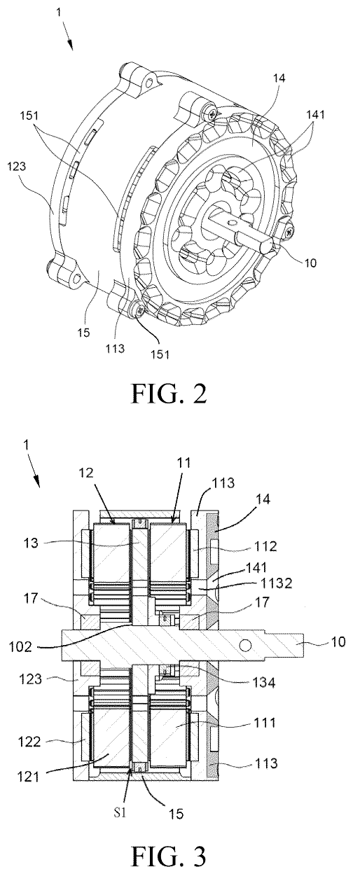

FIG. 1 is a schematic three-dimensional exploded view of an axial-flux motor according to an embodiment of the present disclosure. FIG. 2 is a schematic three-dimensional assembly view of an axial-flux motor according to an embodiment of the present disclosure. FIG. 3 is a schematic cross-sectional assembly view of an axial-flux motor according to an embodiment of the present disclosure. Referring to FIG. 1, FIG. 2, and FIG. 3, the axial-flux motor 1 includes a shaft 10, a wind scooper 14, a first stator assembly 11, a rotor assembly 13, a second stator assembly 12, and a side cover 15. The shaft 10 extends in an axial direction T1, and the wind scooper 14, the first stator assembly 11, the rotor assembly 13 and the second stator assembly 12 are arranged in sequence in the axial direction T1. The rotor assembly 13 is connected to the shaft 10 and configured to rotate together with the shaft 10. The rotor assembly 13 is located in a rotor space S1 formed between the first stator assembly 11 and the second stator assembly 12, whereby a magnetic flux to pass from the first stator assembly 11 to the second stator assembly 12 through the rotor assembly 13. The axial-flux motor 1 of the present disclosure has a structure of double stator assemblies and single rotor assembly, whereby a power density of the axial-flux motor 1 can be effectively increased, and further the efficiency and thrust of the axial-flux motor 1 can be enhanced.

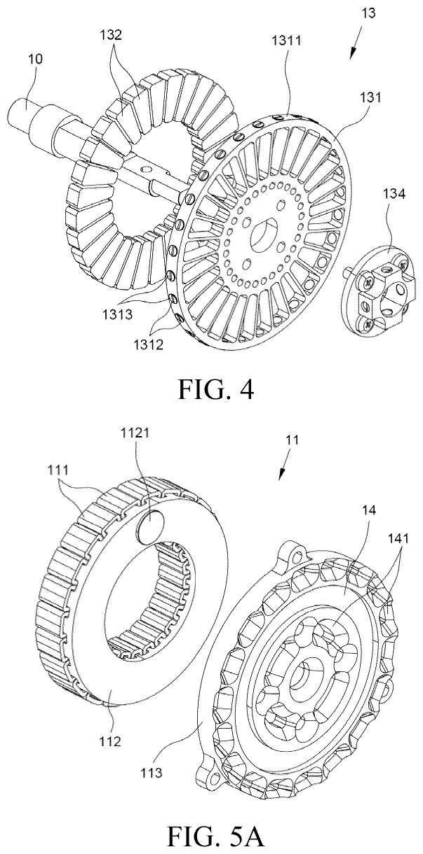

FIG. 4 is a schematic three-dimensional exploded view of a rotor assembly of an axial-flux motor according to an embodiment of the present disclosure. Referring to FIG. 4, the rotor assembly 13 includes an annular support 131 and a plurality of permanent magnets 132. The permanent magnets 132 are arranged in the annular support 131 by an annular arrangement of a single layer. Only a single layer of permanent magnets is arranged on the rotor assembly 13, thereby reducing an amount of permanent magnets and reducing the mass and inertia of the rotor assembly 135. An outer diameter side 1311 of the annular support 131 is provided with a plurality of threaded holes 1312, and the annular support 131 includes a plurality of stop screws 1313 (also referred to as a headless screw). When the permanent magnets 132 are assembled in the annular support 131, the stop screws 1313 are locked in the threaded holes 1312, so that the permanent magnets 132 are fixed in the annular support 131 by the annular arrangement of the single layer. Referring to FIG. 3 and FIG. 4 again, the rotor assembly 13 further includes an aluminum column 134 configured to fix the annular support 131 to the shaft 10.

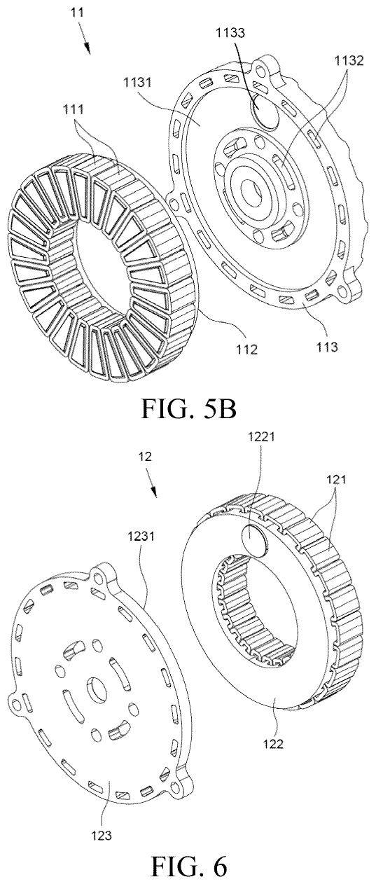

FIG. 5A and FIG. 5B are schematic three-dimensional exploded views I and II of a first stator assembly and a wind scooper of an axial-flux motor according to an embodiment of the present disclosure. Referring to FIG. 1, FIG. 5A, and FIG. 5B, the first stator assembly 11 is arranged on one side of the rotor assembly 13 in the axial direction T1. The first stator assembly 11 includes a plurality of first stator windings 111, a first stator core portion 112, and a first base 113. The first stator windings 111 correspond to permanent magnets 132 of the rotor assembly 13 in the axial direction, and the first stator windings 111 surround the first stator core portion 112 by an annular arrangement. The first stator core portion 112 is fixed to a side 1131 of the first base 113, and the first base 113 is provided with a plurality of first through holes 1132. The first stator core portion 112 is provided with a bump 1121, and the side 1131 of the first base 113 is provided with a recess 1133, to enable the first stator core portion 112 to be correspondingly engaged with the first base 113, thereby preventing the first stator core portion 112 from flying off due to excessively high torque during rotation of the axial-flux motor. Moreover, the first stator core portion 112 is made of a soft magnetic composite (SMC) and integrally formed by using a powder metallurgy process, to improve manufacturability of the axial-flux motor.

FIG. 6 is a schematic three-dimensional exploded view of a second stator assembly of an axial-flux motor according to an embodiment of the present disclosure. Referring to FIG. 6, the second stator assembly 12 is arranged on the other side of the rotor assembly 13 in the axial direction T1. The second stator assembly 12 includes a plurality of second stator windings 121, a second stator core portion 122, and a second base 123. The second stator windings 121 correspond to the permanent magnets 132 of the rotor assembly 13 in the axial direction, the second stator windings 121 surround the second stator core portion 122 by an annular arrangement, and the second stator core portion 122 is fixed to a side 1231 of the second base 123. The second stator core portion 122 is provided with a bump 1221, and the side 1231 of the second base 123 is provided with a recess (not shown), to enable the second stator core portion 122 to be correspondingly engaged with the second base 123, thereby preventing the first stator core portion 112 from flying off due to excessively high torque during rotation of the axial-flux motor. Moreover, the second stator core portion 122 is made of a soft magnetic composite (SMC) and integrally formed by using a powder metallurgy process, to improve manufacturability of the axial-flux motor. Furthermore, as a result of employing the soft magnetic composite (SMC), in terms of an efficiency corresponding to the same rotational speed requirement, the first stator core portion 112 and the second stator core portion 122 have a comparable performance to a silicon steel sheet.

Referring to FIG. 1, FIG. 3, FIG. 5A, and FIG. 5B, in this embodiment, the wind scooper 14 can be joined to the first base 113, and is not used to limit the present disclosure. The wind scooper 14 can be regarded as being fixed to the other side (not shown) of the first base 113 of the first stator assembly 11, and is provided with a plurality of air inlets 141. The air inlets 141 of the wind scooper 14 are respectively communicated with the first through holes 1132 of the first base 113, so that an external airflow enters the axial-flux motor 1 through the air inlets 141 and the first through holes 1132. The air inlets 141 are bell-shaped holes with a width decreasing from outside to inside. The air inlets 141 are arranged by two annular arrangements in a radial direction T2, and the first through holes 1132 are arranged by two annular arrangements in the radial direction T2, so that the external airflow enters a periphery of the first stator windings 111 through the air inlets 141 and the first through holes 1132. The wind scooper 14 can be made of thermally conductive plastic, and the first base 113 and the second base 123 can be made of aluminum metal or aluminum alloy, so as to achieve a light weight and enhance heat dissipation.

Referring to FIG. 1, FIG. 2, and FIG. 3 again, the side cover 15 can be mounted and fixed between the first base 113 and the second base 123 by using a plurality of screws 151, and surrounds the first stator assembly 11, the rotor assembly 13, and the second stator assembly 12. The side cover 15 is provided with a plurality of second through holes 151 to assist in heat dissipation.

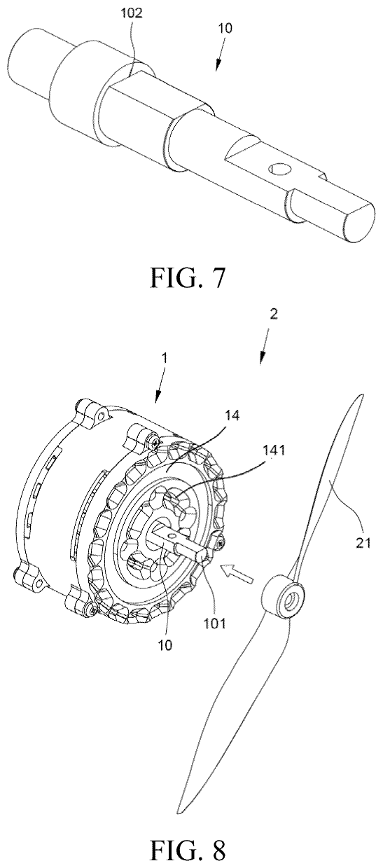

Referring to FIG. 3 again, the axial-flux motor 1 further includes a bearing 17 configured to support the shaft 10. Furthermore, referring to FIG. 4 again, to balance inertia of the rotor assembly 13, a hole needs to be dug in the annular support 131 of the rotor assembly 13, so that a dynamic balancing machine can have a position to replenish clay and achieve weight reduction. FIG. 7 is a schematic three-dimensional view of a shaft of an axial-flux motor according to an embodiment of the present disclosure. Referring to FIG. 7 and FIG. 3, an inner diameter of the rotor assembly 13 and the shaft 10 are designed to have a cutting point 102, so as to avoid slippage during rotation.

FIG. 8 is a schematic three-dimensional view of an unmanned aerial vehicle (UAV) motor device according to an embodiment of the present disclosure. Referring to FIG. 8, the UAV motor device 2 includes a propeller blade 21 and the axial-flux motor 1. The propeller blade 21 is mounted to an end 101 of the shaft 10 of the axial-flux motor 1. To enhance heat dissipation efficiency of the motor, the wind scooper 14 of the axial-flux motor 1 of the present disclosure is provided with the air inlets 141 (for example, a special bell-shaped holes design), so that airflow generated by the propeller blade 21 located above the wind scooper 14 can enter an inside of the axial-flux motor 1 more smoothly, so as to avoid generating airflow disturbance outside the axial-flux motor due to airflow obstruction, and further to affect flight balance of the UAV.

Based on the above, only the preferred implementations or embodiments of the technical means adopted by the present disclosure for resolving the problems are recorded, and are not intended to limit the scope of patent implementation of the present disclosure. To be specific, all equivalent changes and modifications made in accordance with the scope of the patent application of the present disclosure or made in accordance with the scope of the patent of the present disclosure fall within the scope of the patent of the present disclosure.

What is claimed is:

1. An axial-flux motor, comprising:
a shaft, extending in an axial direction;
a rotor assembly, connected to the shaft and configured to rotate together with the shaft;
a first stator assembly, disposed on one side of the rotor assembly in the axial direction, wherein the first stator assembly comprises a plurality of first stator windings, a first stator core portion, and a first base, the first stator windings correspond to permanent magnets of the rotor assembly in the axial direction, the first stator windings surround the first stator core portion by an annular arrangement, the first stator core portion is fixed to the first base, and the first base is provided with a plurality of first through holes;
a second stator assembly, disposed on the other side of the rotor assembly in the axial direction, wherein the rotor assembly is located in a rotor space formed between the first stator assembly and the second stator assembly, whereby a magnetic flux to pass from the first stator assembly to the second stator assembly through the rotor assembly; and
a wind scooper, fixed to the first base of the first stator assembly and provided with a plurality of air inlets, wherein the air inlets are bell-shaped holes with a width decreasing from outside to inside, and the air inlets are communicated with the first through holes of the first base, so that an external airflow enters the axial-flux motor through the air inlets and the first through holes.

2. The axial-flux motor according to claim 1, wherein the rotor assembly comprises an annular support and a plurality of permanent magnets, and the permanent magnets are disposed in the annular support by an annular arrangement of a single layer.

3. The axial-flux motor according to claim 1, wherein the wind scooper is joined to the first base, the wind scooper is made of thermally conductive plastic, and the first base is made of aluminum metal or aluminum alloy.

4. The axial-flux motor according to claim 1, wherein the air inlets are disposed by two annular arrangements in a radial direction, and the first through holes are disposed by two annular arrangements in the radial direction, so that the external airflow enters a periphery of the first stator windings through the air inlets and the first through holes.

5. The axial-flux motor according to claim 1, wherein the second stator assembly comprises a plurality of second stator windings, a second stator core portion, and a second base, the second stator windings correspond to the permanent magnets of the rotor assembly in the axial direction, the second stator windings surround the second stator core portion by an annular arrangement, and the second stator core portion is fixed to the second base.

6. The axial-flux motor according to claim 5, further comprising a side cover mounted and fixed between the first base and the second base and surrounding the first stator assembly, the rotor assembly, and the second stator assembly, wherein the side cover is provided with a plurality of second through holes.

7. The axial-flux motor according to claim 5, wherein the first stator core portion and the second stator core portion each is provided with one of a bump and a recess, and the first base and the second base each is provided with the other of the bump and the recess, to enable the first stator core portion and the second stator core portion to be correspondingly engaged with the first base and the second base.

8. The axial-flux motor according to claim 5, wherein the first stator core portion and the second stator core portion are made of a soft magnetic composite (SMC) and integrally formed by using a powder metallurgy process.

9. The axial-flux motor according to claim 2, wherein an outer diameter side of the annular support is provided with a plurality of threaded holes, the annular support comprises a plurality of stop screws, and when the permanent magnets are assembled in the annular support, the stop screws are locked in the threaded holes, so that the permanent magnets are fixed in the annular support by an annular arrangement of a single layer.

10. An unmanned aerial vehicle (UAV) motor device, comprising a propeller blade and the axial-flux motor according to claim 1, wherein the propeller blade is mounted to an end of the shaft of the axial-flux motor.
